(19) United States
(12) Patent Application Publication
(10) Pub. No.: US 2008/0241569 A1
(43) Pub. Date: Oct. 2, 2008

(54) ENCAPSULATION OF RAMAN ACTIVE NANOPARTICLES

(76) Inventors: Haoyu Qin, San Jose, CA (US); Jingwu Zhang, San Jose, CA (US); Claire E. Dentinger, Sunol, CA (US); Lei Sun, San Clara, CA (US); Xing Su, Cupertino, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/694,293

(22) Filed: Mar. 30, 2007

(51) Int. Cl. B32B 5/16

(52) U.S. Cl. 428/548; 428/403; 977/773; 977/810; 977/838; 977/954

(57) ABSTRACT

Embodiments of the present invention provide methods for coating nanoparticles with polymeric coatings and nanoparticles that are coated with polymeric coatings. The polymeric coatings typically comprise two or more layers wherein the first layer has a charge that is opposite to that of the second layer. In further embodiments, the nanoparticles that can act as labels or reporters are coated with polymeric coatings. Optionally, these reporter or label nanoparticles may be Raman-active, such that they provide a distinctive Raman signature upon excitation with electromagnetic radiation.

### CROSS-REFERENCE TO RELATED APPLICATIONS

The present application is related to U.S. patent application Ser. No. 10/940,698, entitled “External Modification of Composite Organic Inorganic Nanoclusters,” filed Sep. 13, 2004, now pending, and U.S. patent application Ser. No. 11/643,426, entitled “Self-assembling Raman-active Nanoclusters,” filed Dec. 21, 2006, now pending, the disclosures of which are incorporated herein by reference.

### BACKGROUND OF THE INVENTION

1. Field of the Invention

The embodiments of the present invention relate generally to nanoclusters that include metal nanoparticles and organic compounds, nanoclusters and nanoparticles that include polymer layers, and to the use of nanoparticles and nanoclusters in analyte detection by surface-enhanced Raman spectroscopy.

2. Background Information

The ability to detect and identify trace quantities of analytes has become increasingly important in many scientific disciplines, ranging from part per billion analyses of pollutants in sub-surface water to analysis of drugs and metabolites in blood serum. Additionally, the ability to perform assays in multiplex fashion greatly enhances the rate at which information can be acquired. Devices and methods that accelerate the elucidation of disease origin, creation of predictive and or diagnostic assays, and development of effective therapeutic treatments are valuable scientific tools. A principle challenge is to develop an identification system for a large probe set that has distinguishable components for each individual probe.

Among the many analytical techniques that can be used for chemical analyses, surface-enhanced Raman spectroscopy (SERS) has proven to be a sensitive method. A Raman spectrum, similar to an infrared spectrum, consists of a wavelength distribution of bands corresponding to molecular vibrations specific to the sample being analyzed (the analyte). Raman spectroscopy probes vibrational modes of a molecule and the resulting spectrum, similar to an infrared spectrum, is fingerprint-like in nature. As compared to the fluorescent spectrum of a molecule which normally has a single peak exhibiting a half peak width of tens of nanometers to hundreds of nanometers, a Raman spectrum has multiple structure-related peaks with half peak widths as small as a few nanometers.

To obtain a Raman spectrum, typically a beam from a light source, such as a laser, is focused on the sample generating inelastically scattered radiation which is optically collected and directed into a wavelength-dispersive spectrometer. Although Raman scattering is a relatively low probability event, SERS can be used to enhance signal intensity in the resulting vibrational spectrum. Enhancement techniques make it possible to obtain a 10⁶ to 10¹⁴ fold Raman signal enhancement.

SERS effect is attributed mainly to electromagnetic field enhancement and chemical enhancement. It has been reported that silver particle sizes within the range of 50-100 nm are most effective for SERS. Theoretical and experimental studies also reveal that metal particle junctions are the sites for efficient SERS.

### BRIEF DESCRIPTION OF THE FIGURES

FIG. 1 diagrams a coating scheme in which a nanoparticle is coated with a first charged polymer layer and then is coated with a second charged layer. The second charged layer has a charge that is opposite that of the first charged layer. Optionally, additional polymer layers may be added.

FIGS. 2A, 2B, 2C, 2D, and 2E provide some exemplary synthetic reactions for creating charged chemically modified synthetic polymers and some exemplary charged synthetic polymers.

FIG. 3 shows a coated nanoparticle that has been complexed with an antibody that can be used as a probe molecule.

FIGS. 4A and 4B show Raman spectra obtained from COINs (composite organic inorganic nanoclusters) that incorporate a single type of Raman label and three different Raman labels, respectively. (Key: 8-aza-adenine (AA), 9-aminoacridine (AN), methylene blue (MB).) Representative peaks are indicated by arrows; peak intensities have been normalized to respective maximums; the Y axis values are in arbitrary units; spectra are offset by 1 unit from each other.

FIGS. 5A and 5B show signatures of COINs with double and triple Raman labels. The three Raman labels used were 8-aza-adenine (AA), 9-aminoacridine (AN), and methylene blue (MB). The main peak positions are indicated by arrows; the peak heights (in arbitrary units) were normalized to respective maximums; spectra are offset by 1 unit from each other.

FIGS. 6A and 6B demonstrate the UV absorbance increase at 250 nm resulting from the chemical modification of a charged polymer that adds a conjugated carboxylic acid group.

FIG. 7 shows the resulting size increase after nanoparticle encapsulation with charged polymer layers.

FIG. 8 shows the zeta potential changes resulting from the nanoparticle encapsulation with charged polymer layers.

FIG. 9 provides Raman spectra of two nanoparticle reporters, one that had been encapsulated with a protein layer and one that had been encapsulated with two oppositely charged polymer layers.

FIG. 10 shows a stability comparison for nanoparticles encapsulated with charged polymers and nanoparticles encapsulated with a protein layer

FIG. 11 shows results obtained from a bioassay performed with nanoparticle reporters encapsulated with charged polymer layers.

FIG. 12 is a simplified diagram showing a method by which electrostatic interactions are used to build a nanoparticle comprising a cluster of smaller nanoparticles.

FIGS. 13A, 13B, and 13C provide simplified diagrams of three different exemplary nanoparticles that can be used as labels or reporters.

FIG. 14 diagrams a method by which a desired charge can be placed on a nanoparticle.

FIG. 15 shows two exemplary motifs for Raman label placement in a nanocluster.

FIG. 16 schematically describes a Raman spectrometer that can be used for SERS measurements.

### DETAILED DESCRIPTION OF THE INVENTION

Nanoparticles capable of providing distinctive signals in response to excitation with electromagnetic radiation have been prepared and a variety of examples exist. Some nanoparticle reporters are described herein. The preparation of nanoparticles that are capable of acting as reporters (tags or labels) having a variety of distinctive signals enables multiplexed analyses to be performed. An analysis scheme typically would be, for example, attaching a probe, a molecule that specifically recognizes and attaches to a known analyte, to the nanoparticle reporter, mixing the probe-nanoparticle reporter complex with a solution to be analyzed for the presence of a known substance (analyte) under conditions that allow the probe to specifically bind to any analyte that may be present in the sample, removing any unbound probe-nanoparticle reporter complexes, and detecting the presence of the bound probe-nanoparticle reporter complexes. Having probes that provide a multiplicity of distinguishable reporter signals allows assays for a plurality of known analytes to be performed in a multiplexed fashion by attaching different probes to unique reporters and detecting the unique reporter signals after allowing the reporters to form complexes with their respective analytes and separating out any uncomplexed reporter molecules.

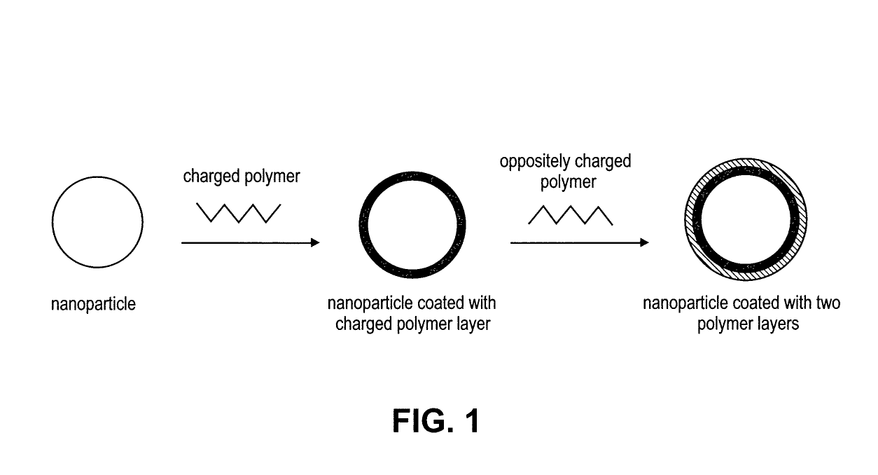

Embodiments of the present invention provide coatings and methods of coating nanoparticles. In general, coating nanoparticles according to embodiments of the present invention enhances the stability of the nanoparticle and provides attachment sites for molecules, such as for example, probes. FIG. 1 shows a general method for coating nanoparticles. In FIG. 1, a nanoparticle is coated with a layer of charged polymer. This polymer layer may be either positively charged or negatively charged. In the next reaction, the coated nanoparticle is coated with a second layer of charged polymer. The second layer of charged polymer has a charge that is opposite of that of the first layer, so that, for example, if the first layer is positively charged, the second layer will be negatively charged. The coated nanoparticle may be coated with additional layers, so that a resulting nanoparticle may have 2, 3, 4, 5, or more layers as desired by the user. Optionally, the nanoparticle may be coated with a first layer, such as for example, a protein layer, such as BSA (bovine serum albumen) layer, a polymer layer, a metal layer, or silica layer, before the oppositely charged polymer layers are applied. Also optionally, the polymer layers may be stabilized with one or a combination of the following: (a) mix the polymer for outermost layer coating with other polymers which can form polymer complex with this outermost layer polymer and repeat the coating process with this mixture, (b) chemically crosslink one or more of the charged polymer layers, (c) ionically crosslink one or more of the charged polymer layers, or (4) crosslink one or more of the charged polymer layers through photo initiated polymerization. Ionic crosslinking is a method in which an oppositely charged ion is introduced to crosslink two or more layers of a charged polymer. For example, negatively charged chlorosulfonated polyethylene polymers can be stabilized by heating with divalent metal oxides or hydroxides and rosin acids. These polymers are crosslinked by the formation of metal-sulfonate bonds. See for example, Maynard, J. T. and Johnson, P. R., “Ionic crosslinking of chlorosulfonated polyethylenes,” J. App. Pol. Sci., 7:5. 1943-1950 (2003); “Ionic crosslinking of an ethylene copolymer in twin-screw extruder,” U.S. Pat. No. 5,003,001; and “Crosslinked polymer, electrolyte using the polymer, and nonaqueous secondary battery using the electrolyte,” U.S. Pat. No. 6,406,817. Ionic crosslinking agents include, for example, cationic quaternary ammonium polymers, such as poly(4-vinyl-1-methylpyridinium bromide) (commercially available from Polysciences, Inc., Warrington, Pa.), and metal salts. Chemical crosslinkers include, for example, propylene glycol diglycidyl ether which is capable of crosslinking amine-, hydroxyl-, and carboxyl-functionalized polymers (commercially available from Polysciences, Inc., Warrington, Pa.). Additional polymer crosslinking examples can be found in Shan, Guo-Rong, Xu, Ping-Ying, Weng, Zhi-Xue, and Huang, Zhi-Ming, “Oil-absorption function of physical crosslinking in the high-oil-absorption resins,” J. App. Pol. Sci., 90:14, 3495-3950, (2003); and Weadock, K. S., Miller, E. J., Keuffel, E. L., Dunn, M. G., “Effect of physical crosslinking methods on collagen-fiber durability in proteolytic solutions,” J. Biomed. Mat. Res., 32:2, 221-2226 (1998).

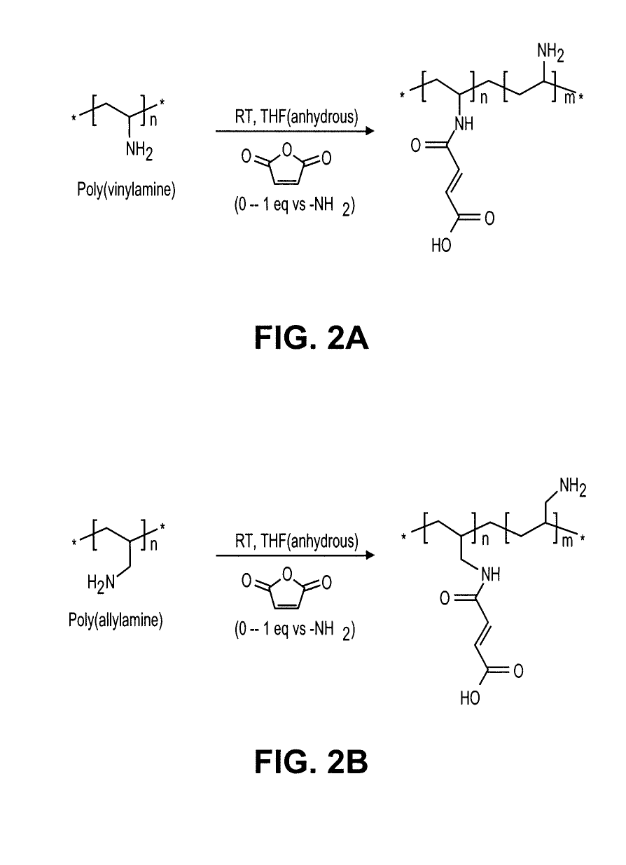

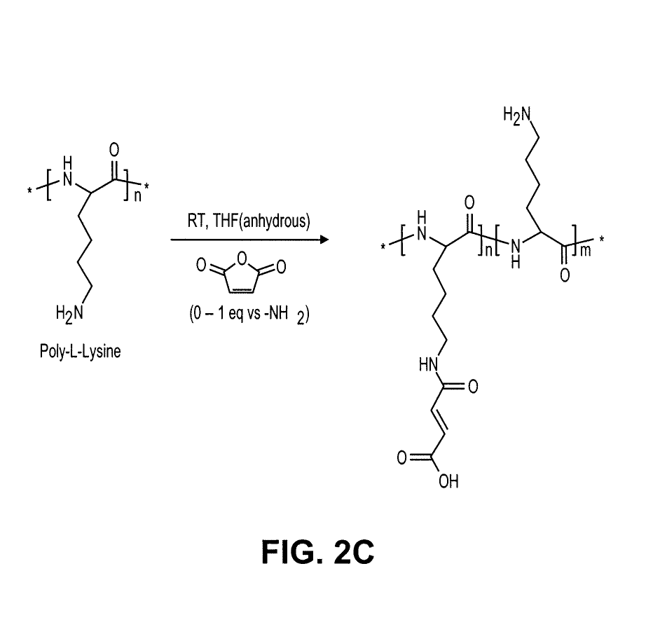

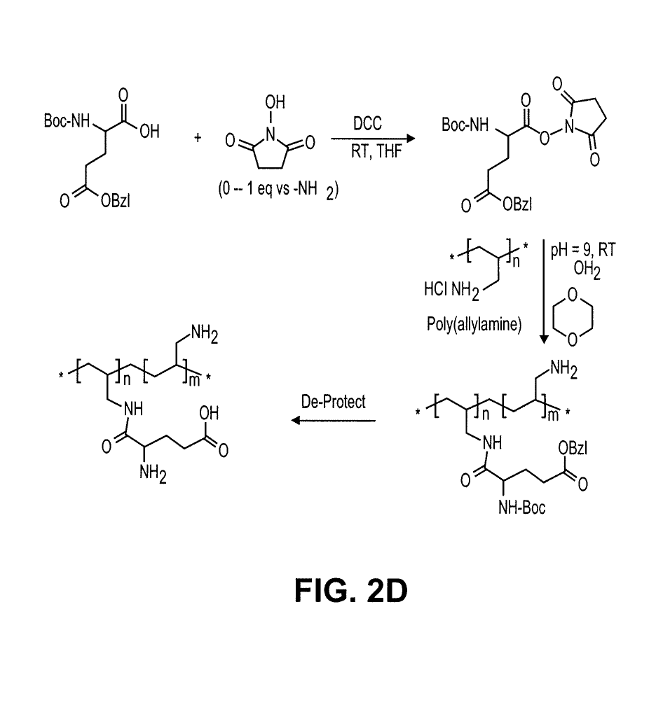

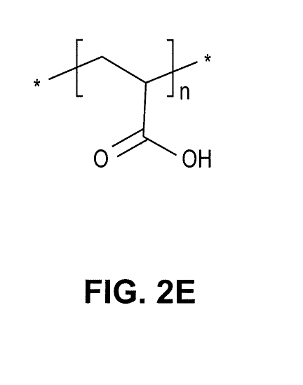

Positively charged polymers that may be used include for example, poly(vinylamine), poly(allylamine), poly-lysine, as well as copolymers of these polymers. Typically, the molecular weight of the polymer ranges from about 15,000 to about 100,000. The reagents used to modify the synthetic polymer are not limited to the examples in FIG. 2, as many compounds that easily react with nucleophiles, such as for example, maleic anhydride, alkyl halides, acyl halides, and carbonyl compounds, may be used to modify the polymers. FIG. 2 provides some synthetic routes for exemplary negatively charged synthetic polymers that may be used in embodiments of the present invention. The molar ratio of polymer modification reagent to nucleophilic site on the polymer typically will range from greater than 0 to 1. Changing the molar ratio of polymer modification reagent to polymer nucleophilic site allow the charge level on the polymer to be adjusted. A larger molar ratio of polymer modification reagent to nucleophilic site will result in a more highly charged polymer.

Referring now to FIG. 2A, a poly(vinylamine) polymer is reacted with maleic anhydride in anhydrous THF (tetrahydrofuran) at room temperature (RT) to yield a modified polymer having a carboxylic acid group. In FIG. 2B a poly(allylamine) polymer is reacted with maleic anhydride in anhydrous THF (tetrahydrofuran) at room temperature (RT) to yield a modified polymer having a carboxylic acid group. In FIG. 2C a poly-L-lysine polymer is reacted with maleic anhydride in anhydrous THF (tetrahydrofuran) at room temperature (RT) to yield a modified polymer having a carboxylic acid group. In FIG. 2D a poly(allylamine) polymer is modified to include a peptide bond, an additional amine group, and a carboxylic acid functional group (in this Figure, DCC is N,N′-dicyclohexylcarbodiimide).

In further embodiments, the positively charged polymer is modified with amino acids and amino acid mimetics via peptide synthesis chemistry. Derivatizing synthetic polymers with charged amino acids and or amino acid mimetics provides the polymer with similar physical properties as those of natural protein.

Negatively charged polymers useful in embodiments of the present invention include, for example, poly(acrylic acid), poly (methacrylic acid), and polyelectrolytes, such as poly(sodium styrene sulfonate). The negative polymers have molecular weights ranging from 2,000 to 3,000,000. These negatively charged polymers optionally are modified through chemical reactions, such as EDC (1-ethyl-3-(3-dimethyl aminopropyl)carbodiimide) coupling reactions, a reaction that couples carboxylic acid functional groups of the polymer with amine groups of a chemical modification reagent.

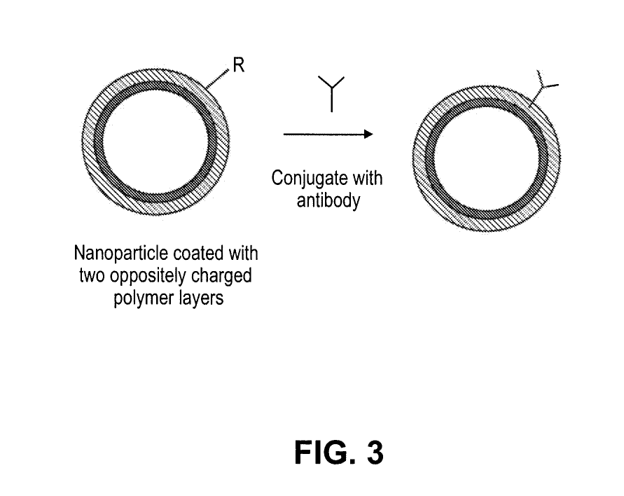

FIG. 3 provides a simplified diagram of a coated nanoparticle being conjugated with a probe. In this example, the probe is an antibody and R is a functional group amenable to coupling reactions that is available on the nanoparticle surface, such as for example, an amino group or a thiol group. In the case of a nanoparticle having an external layer that is a charged polymer, the R functional group is provided by the charged polymer. In general, and as described more fully herein, a probe molecule is generally a molecule that is capable of recognizing (selectively binding to) an analyte of interest. Exemplary probes include antibodies, antigens, polynucleotides, oligonucleotides, carbohydrates, proteins, cofactors, receptors, ligands, peptides, inhibitors, activators, hormones, cytokines, and the like. For example, the analyte can be a protein and the nanocluster is complexed to the analyte through an antibody that specifically recognizes the protein analyte of interest.

Composite organic inorganic nanoclusters (COINs) are sensitive Raman-active reporters that can be used in multiplexed analysis of many types of samples. Generally, COINs are composed of a metal and at least one organic Raman-active compound. Interactions between the metal of the clusters and the Raman-active compound(s) enhance the Raman signal obtained from the Raman-active compound(s) when the nanoparticle is excited by a laser. Since a large variety of organic Raman-active compounds can be incorporated into the nanoclusters, a set of Raman-active nanoclusters can be created in which each member of the set has a Raman signature unique to the set. Thus, COINs can also function as sensitive reporters for highly parallel analyte detection. Furthermore, not only are the intrinsic enhanced Raman signatures of the nanoparticles of the present invention sensitive reporters, but sensitivity may also be further enhanced by incorporating thousands of Raman labels into a single nanocluster and or attaching multiple nanoclusters to a single analyte.

It was found that aggregated metal colloids fuse at elevated temperature and organic Raman labels can be incorporated into the coalescing metal particles. These coalesced metal particles form stable clusters and produce intrinsically enhanced Raman scattering signals from the incorporated organic label(s). These stable clusters containing organic molecules incorporated within and as part of the cluster are COINs.

The interaction between the organic Raman label molecules and the metal colloids of the nanoparticle cluster has mutual benefits. Besides serving as signal sources, the organic molecules induce a metal particle association that is in favor of electromagnetic signal enhancement. Additionally, the internal nanocluster structure provides spaces to hold Raman label molecules, especially in the junctions between the metal particles that make up the cluster. In fact, it is believed that the strongest enhancement is achieved from the organic molecules located in the junctions between the metal particles of the nanoclusters.

Generally, the nanoclusters are less than 1 μm in size, and are formed by particle growth in the presence of organic compounds. The preparation of such nanoparticles also takes advantage of the ability of metals to adsorb organic compounds. Indeed, since Raman-active organic compounds are adsorbed onto the metal cluster during formation of the metallic colloids, many Raman-active organic compounds can be incorporated into a nanoparticle.

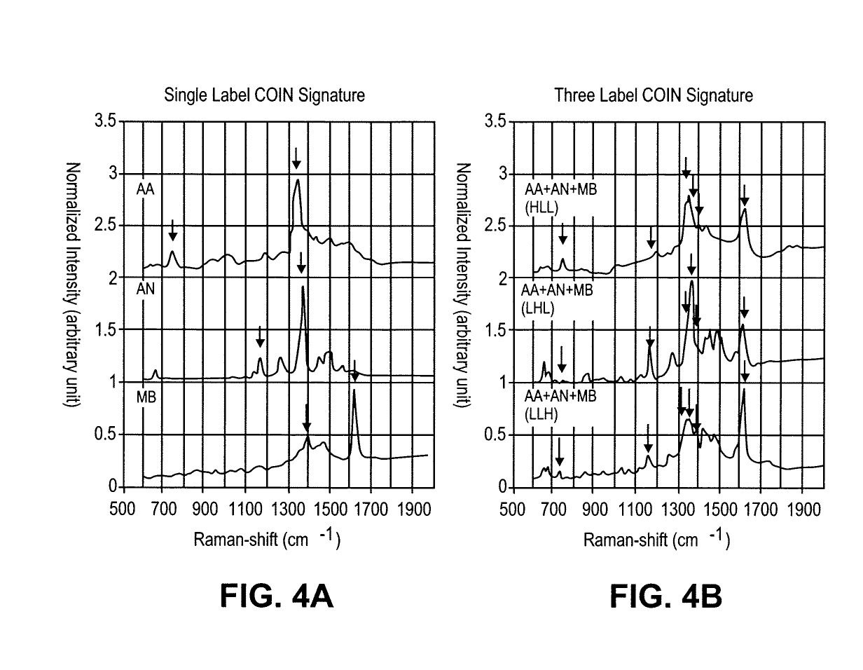

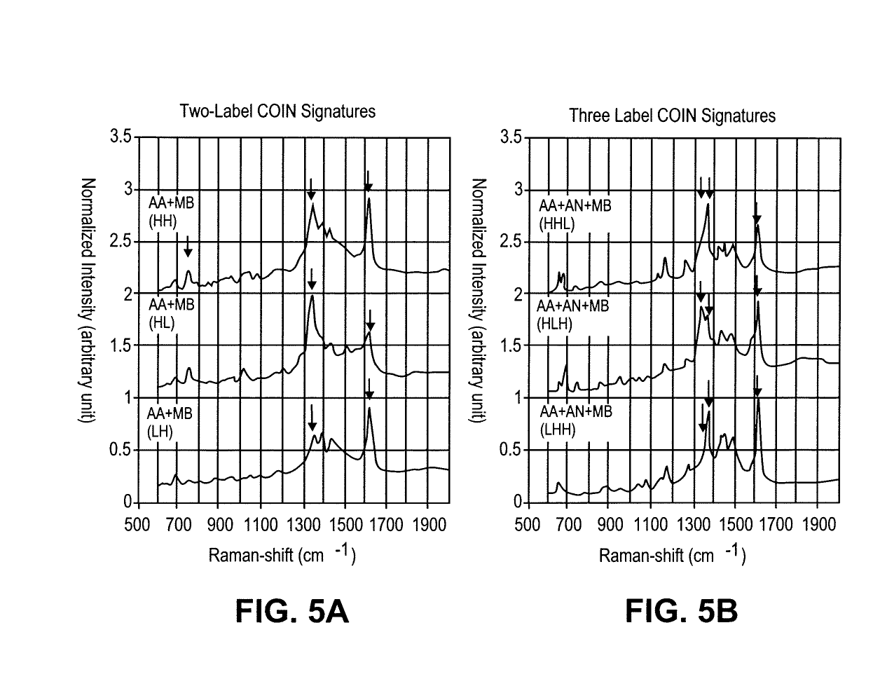

Not only can COINs be synthesized with different Raman labels, but COINs may also be created having different mixtures of Raman labels and also different ratios of Raman labels within the mixtures. Referring now to FIGS. 4 and 5, FIG. 4A shows signatures of COINs made with a single Raman-active organic compound, demonstrating that each Raman-active organic compound produced a unique signature. FIG. 4B shows signatures of COINs made with mixtures of three Raman labels at concentrations that produced signatures as indicated: HLL means high peak intensity for 8-aza-adenine (AA) (H) and low peak intensity for both 9-aminoacridine (AN) (L) and methylene blue (MB) (L); LHL means low peak intensity for AA (L), high peak intensity for AN(H) and low for MB (L); LLH means low for both AA (L) and AN (L) and high for MB (H). COINs in these examples were made with individual or mixtures of Raman labels at concentrations from 2.5 μM to 20 μM, depending on the signature desired. Peak heights can be adjusted by varying label concentrations, but they might not be proportional to the concentrations of the labels used due to different absorption affinities of the Raman labels for the metal surfaces. FIG. 5A shows signatures of COINs made with two Raman labels (AA and MB) at concentrations designed to achieve the following relative peak heights: AA=MB (HH), AA greater than MA (HL), and AA less than MB (LH). FIG. 5B shows Raman signatures of COINs made from mixtures of the three Raman labels at concentrations that produced the following signatures: HHL means high peak intensities for AA (H) and AN(H) and low peak intensity for MB (L); HLH means high peak intensity for AA (H), low peak intensity for AN (L), and high peak intensity for MB (H); and LLH means low peak intensities for AA (L) and AN (L), and high peak intensity for MB (H). COINs in these examples were made by the oven incubation procedure with mixtures of two or three Raman labels at concentrations from 2.5 to 20 μM, depending on the signatures desired. Thus, it is possible to create a large number of different molecular identifiers using the COINs of the present invention. Theoretically, over a million COIN signatures could be made within the Raman shift range of 500-2000 cm⁻¹.

Table 1 provides examples of the types of organic compounds that can be used to build COINs. In general, Raman-active organic compound refers to an organic molecule that produces a unique SERS signature in response to excitation by a laser. Typically the Raman-active compound has a molecular weight less than about 500 Daltons.

TABLE 1

| Abbreviation | Name | Structure |
|---|---|---|
| AAD (AA) | 8-Aza-adenine | 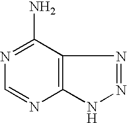 |
| BZA (BA) | N-Benzoyladenine | 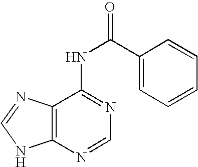 |
| MBI | 2-Mercapto-benzimidazole | 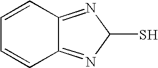 |
| APP | 4-Amino-pyrazole[3,4-d]pyrimidine | 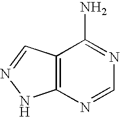 |
| ZEN | Zeatin | 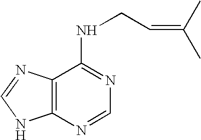 |
| MBL (MB) | Methylene Blue | 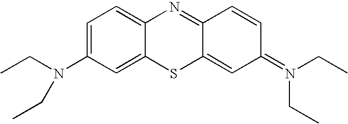 |
| AMA (AN,AM) | 9-Amino-acridine | 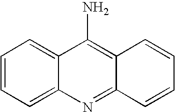 |
| EBR | Ethidium Bromide | 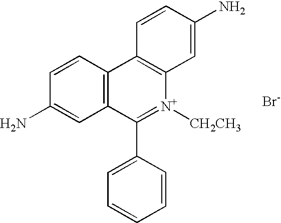 |
| BMB | Bismarck Brown Y | 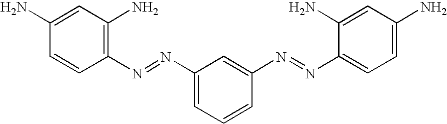 |
| NBA | N-Benzyl-aminopurine | 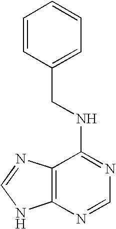 |
| THN | Thionin acetate | 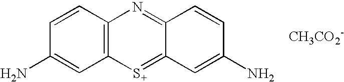 |
| DAH | 3,6-Diaminoacridine | 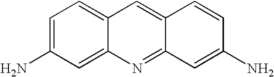 |
| CYP | 6-Cyanopurine | 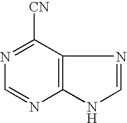 |
| AIC | 4-Amino-5-imidazole-carboxamidehydrochloride | 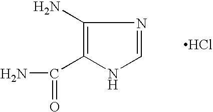 |
| DII | 1,3-Diiminoisoindoline | 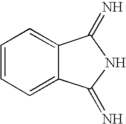 |
| R6G | Rhodamine 6G | 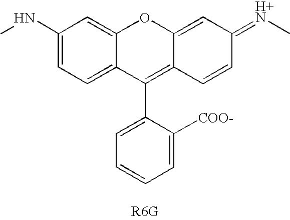 |
| CRV | Crystal Violet | 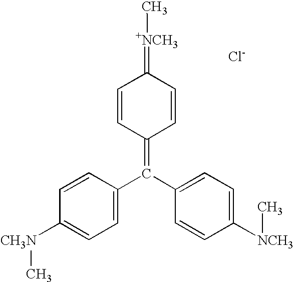 |
| BFU | Basic Fuchsin | 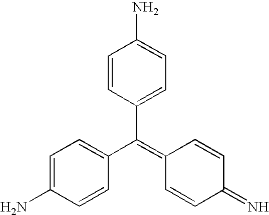 |
| ANB | Aniline Blue Diammonium salt | 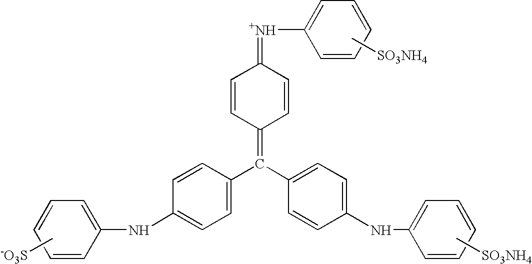 |
| ACA | N-[(3-(Anilinomethylene)-2-chloro-1-cyclohexen-1-yl)methylene]anilinemonohydrochloride | 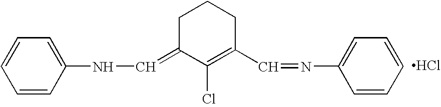 |
| ATT | O-(7-Azabenzotriazol-1-yl)-N,N,N′,N′-tetramethyluroniumhexafluorophosphate | 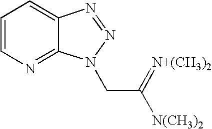 |
| AMF | 9-Aminofluorene hydrochloride | 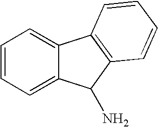 |
| BBL | Basic Blue | 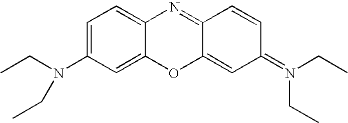 |
| DDA | 1,8-Diamino-4,5-dihydroxyanthraquinone | 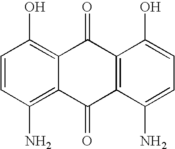 |
| PFV | Proflavine hemisulfate salt hydrate | 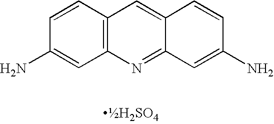 |
| APT | 2-Amino-1,1,3-propenetricarbonitrile | 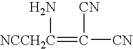 |
| VRA | Variamine Blue RT salt | 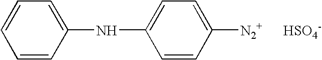 |
| TAP | 4,5,6-Triaminopyrimidine sulfatesalt | 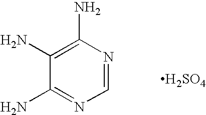 |
| ABZ | 2-Amino-benzothiazole | 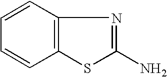 |
| MEL | Melamine | 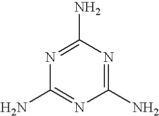 |
| PPN | 3-(3-Pyridylmethylamino)Propionitrile | 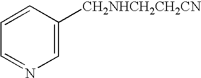 |
| SSD | Silver(I) Sulfadiazine | 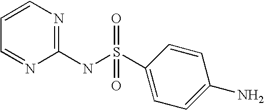 |
| AFL | Acriflavine | 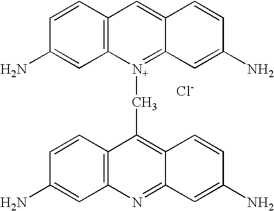 |
| AMPT | 4-Amino-6-mercaptopyrazole[3,4-d]pyrimidine | 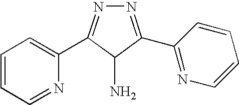 |
| APU | 2-Aminopurine | 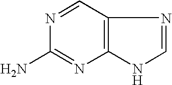 |
| ATH | Adenine Thiol | 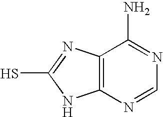 |
| FAD | Fluoroadenine | 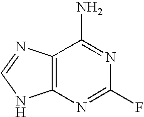 |
| MCP | 6-Mercaptopurine | 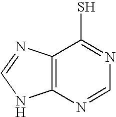 |
| AMP | 4-Amino-6-mercapyopyrazole[3,4-d]pyrimidine | 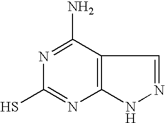 |
| R110 | Rhodamine 110 | 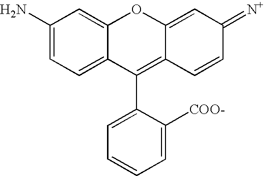 |
| ADN | Adenine | 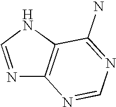 |
| AMB | 5-Amino-2-mercaptobenzimidazole | 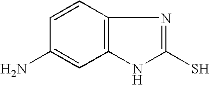 |

Many compounds that give strong regular Raman signals in solution do not yield strong signals in COINs. Further, within a particular compound, vibration modes that give strong regular Raman peaks in solution do not necessarily produce strong peaks in COINs. Strong signals from COINs are desirable in applications such as the detection of analytes that are present at low concentrations. It was found, for example, that the organic compounds shown in Table 2 produced strong Raman signals upon incorporation into the COIN nanocluster.

TABLE 2

| Abbreviation | Name | Structure |
|---|---|---|
| AOH | Acridine Orange Hydrochloride | 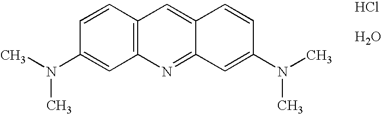 |
| CVA | Cresyl Violate Acetate | 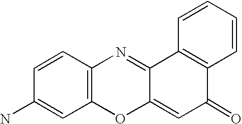 |
| AFN | Acriflavine Neutral | 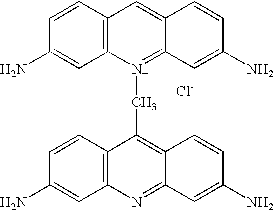 |
| DMB | Dimidium Bromide | 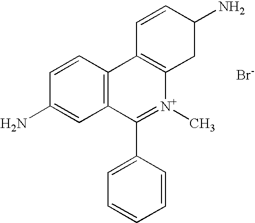 |
| TMP | 5,10,15,20-Tetrakis(N-methyl-4-pyridinio)porphyrin Tetra(p-toluenesulfonate) | 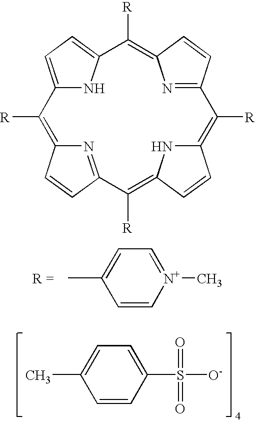 |
| TTP | 5,10,15,20-Tetrakis(4-trimethylaminophenyl)porphyrinTetra(p-toluenesulfonate) | 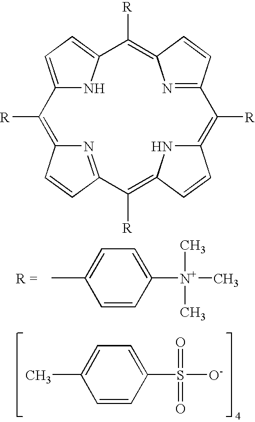 |
| DAA | 3,5-Diaminoacridine Hydrochloride | 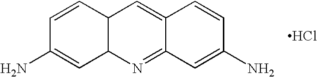 |
| PII | Propidium Iodide (3,8-diamino-5-(3-diethylaminopropyl)-6-phenylphenanthridinium iodidemethiodide | 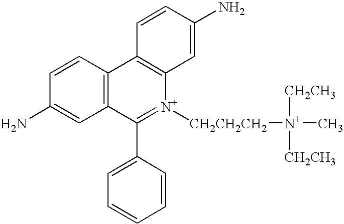 |
| MPI | Trans-4-[4-(dimethylamino)styryl]-1-methylpyridinium iodide | 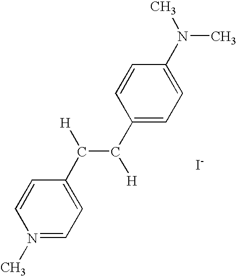 |
| DAB | 4-((4-(dimehtylamino)phenyl)azo)benzoicacid, succinimidyl ester | 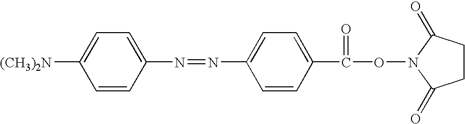 |

In general, COINs can be prepared by causing colloidal metallic nanoparticles to aggregate in the presence of an organic Raman label. The colloidal metal nanoparticles can vary in size, but are chosen to be smaller than the desired size of the resulting COINs. For some applications, for example, in the oven and reflux synthesis methods, silver particles ranging in average diameter from about 3 to about 12 nm were used to form silver COINs and gold nanoparticles ranging from about 13 to about 15 nm were used to make gold COINs. In another application, for example, silver particles having a broad size distribution of about 10 to about 80 nm were used in a cold synthesis method. Additionally, multi-metal nanoparticles may be used, such as, for example, silver nanoparticles having gold cores.

To prepare colloidal metal nanoparticles, an aqueous solution is prepared containing suitable metal cations and a reducing agent. The components of the solution are then subject to conditions that reduce the metallic cations to form neutral, colloidal metal particles. Since the formation of the metallic clusters occurs in the presence of a suitable Raman-active organic compound, the Raman-active organic compound is readily incorporated onto the metal nanocluster during colloid formation. It is believed that the organic compounds trapped in the junctions between the primary metal particles provide the strongest Raman signal. COINs can typically be isolated by membrane filtration and COINs of different sizes can be enriched by centrifugation. Typical metals contemplated for use in formation of nanoclusters from metal colloids include metals capable of providing surface enhanced Raman spectra for organic label molecules and include, for example, silver, gold, copper, platinum, palladium, aluminum, gallium, indium, rhodium, and the like. In some embodiments the metal is silver or gold.

For organic Raman label compounds that tend to not cause colloid aggregation, an aggregation-inducing agent can be used. For example, the aggregation-inducing agent can be a salt, such as LiCl or NaCl, an acid or a base, such as HNO₃, HCl, or NaOH, or an organic compound, such as adenine, or benzyl-adenine. When aggregation-inducing agents are used, COIN synthesis can be performed at room temperature. Performing synthesis at room temperature is useful for making COINs from fluorescent dyes, since some of them can be unstable at elevated temperatures.

In general, for applications using COINs as reporters for analyte detection, the average diameter of the COIN particle should be less than about 200 nm. Typically, in analyte detection applications, COINs will range in average diameter from about 30 to about 200 nm. More preferably COINs range in average diameter from about 40 to about 200 nm, and more preferably from about 50 to about 200 nm, more preferably from about 50 to about 150 nm, and more preferably about 50 to about 100 nm.

COINs may optionally be coated with metal layers, adsorption layers, silica layers, hematite layers, organic layers, and organic thiol-containing layers. Typically, the metal layer is different from the metal used to form the COIN. Additionally, a metal layer can typically be placed underneath any of the other types of layers. Many of the layers, such as the adsorption layers and the organic layers provide additional mechanisms for probe attachment. For instance, layers presenting carboxylic acid functional groups allow the covalent coupling of a biological probe, such as an antibody, through an amine group on the antibody.

FIG. 1 shows the general procedure to encapsulate the Raman-active nanoparticles, such as, for example, COINS, using the Layer-By-Layer (LBL) coating method of the present invention. For example, the uncoated Raman-active nanoparticles are concentrated into a pH controlled medium, such as a buffer solution or DI (deionized) water. The resulting suspension of Raman-active nanoparticles is mixed with a solution of charged polymers, either a positively or a negatively charged polymer. The mixture is incubated at room temperature, for example. This coating procedure is then repeated with oppositely charged polymers as compared to those used in immediate previous coating step. Coatings are applied until the desired number of polymer layers achieved. Optionally, a physical treatment can be applied on these coated Raman-active nanoparticles, such as for example, incubating the particles at elevated temperature, or exposing the particles to light. Further optionally, the multiple layers of the LBL encapsulation may be stabilized with one or combination of the following procedures, (a) mix the polymer for outermost layer coating with other polymers which can form polymer complex with this outermost layer polymer and repeat coating process with this mixtures, (b) chemically crosslinking the outer layer or between layers, (c) ionically crosslinking the outer layer or between layers, and or (4) photo initialized polymerization to crosslink outer layer or between layers.

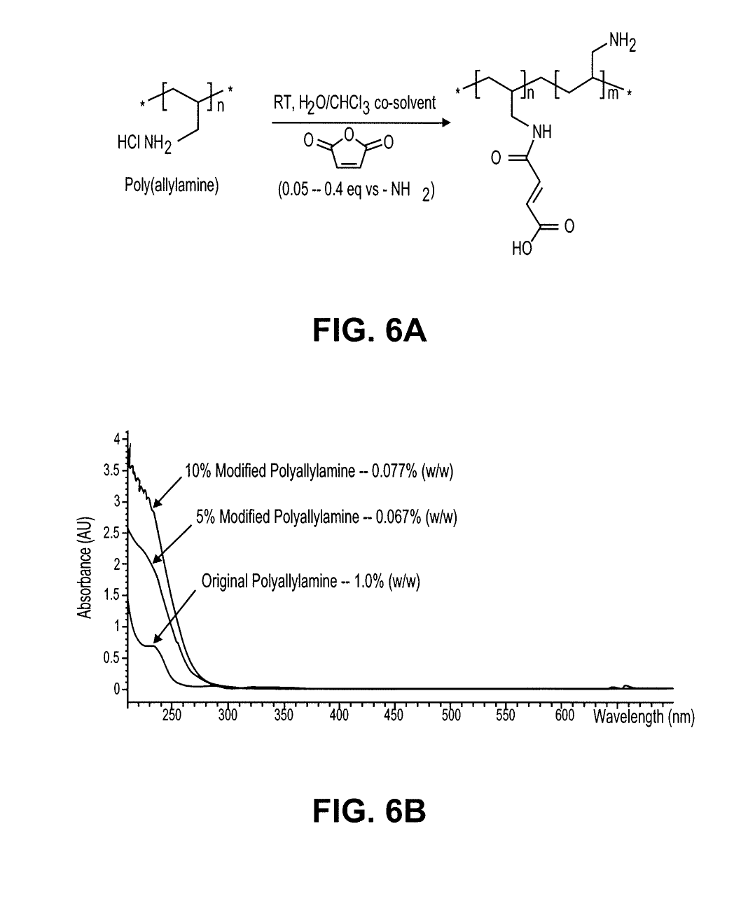

FIG. 6A shows a modification procedure and the chemical structure of a modified positively charged poly(allylamine) polymer. After modification, certain amounts of nucleophiles on polymers have been attached with conjugated double bonds. These conjugated systems will have the UV absorbances at 250 nm. This characteristic absorbance can be used to identify the success of chemical modification of a charged polymer. FIG. 6B shows the results of UV measurements of modified and non-modified positively charged polymers. The chemically modified polymers have been dialyzed with membrane (MWCO=1000) against DI water to remove free small molecules. As can been seen in FIG. 6B, a greater amount of chemical modification results in an increased UV absorbance at 250 nm.

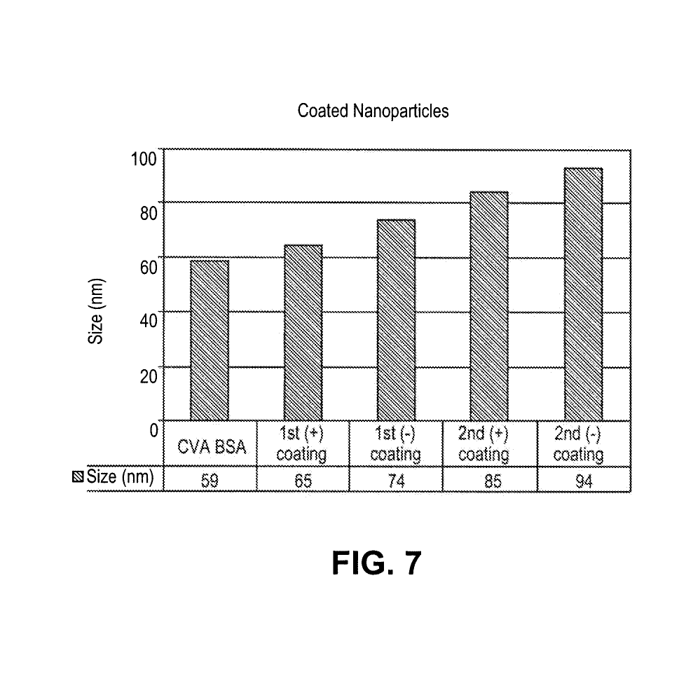

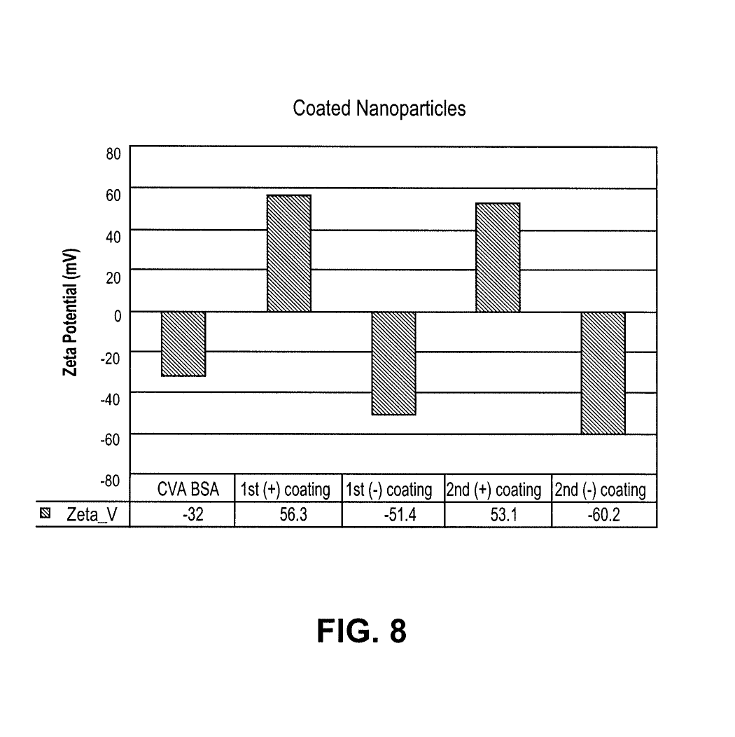

FIG. 7 shows the effect of charged polymeric layer coatings on the resulting size of the coated nanoparticles. In this example, the encapsulated nanoclusters were prepared as follows. A 2000 ppm solution of poly(allylamine) hydrochloride (molecular weight 70 K) in water was prepared as a positive polymer coating material. A 2000 ppm solution of poly(acrylic acid) (molecular weight 100 K) in water was prepared as a negative polymer coating material. 25 mL of a solution of BSA-coated (CVA) COINs (CVA is cresyl violate acetate and refers to the type of Raman label in the COINs) was placed in a 50 mL conical centrifuge tube and centrifuged at 7000 g for 7 minutes. The supernatant was removed and 250 μL of residue was left in the tube. After removing the supernatant from the tubes, 1.25 mL of DI water was added to the tube and a suspension formed. The suspension was added to 1.25 mL of the positive polymer solution prepared as above and mixed. The tube was kept from light and left at room temperature for 16 hours. The size of the coated nanoparticles was measured with a ZetaSizer Nano (from Malvern) by using the following solution: 10 μL of COIN suspension diluted in 1 mL DI water. Two more layers were added using a similar procedure. The labels in FIG. 7 are as follows: “CVA BSA” indicates COINs having no polymer layer coatings, “1^{st} (+) coating” indicates CVA COINs having a first positively charged polymer layer, “1^{st} (−) coating” indicates CVA COINs having two charged polymer layers, a positively charged one and a negatively charged one, “2^{nd} (+) coating” indicates CVA COINs having three polymer layers, a positively charged one, a negatively charged one, and a positively charged one, and “2^{nd} (−) coating” indicates CVA COINs having four charged polymer layers, two positively charged layers alternating with two negatively charged layers. As can be seen in FIG. 7, the layers of charged polymer added to the nanoparticles caused the size of the nanoparticles to increase. FIG. 8 shows the zeta potentials of these same CVA COIN nanoparticles that have from one to four charged polymer layer coatings. Data was collected on a ZetaSizer Nano (from Malvern).

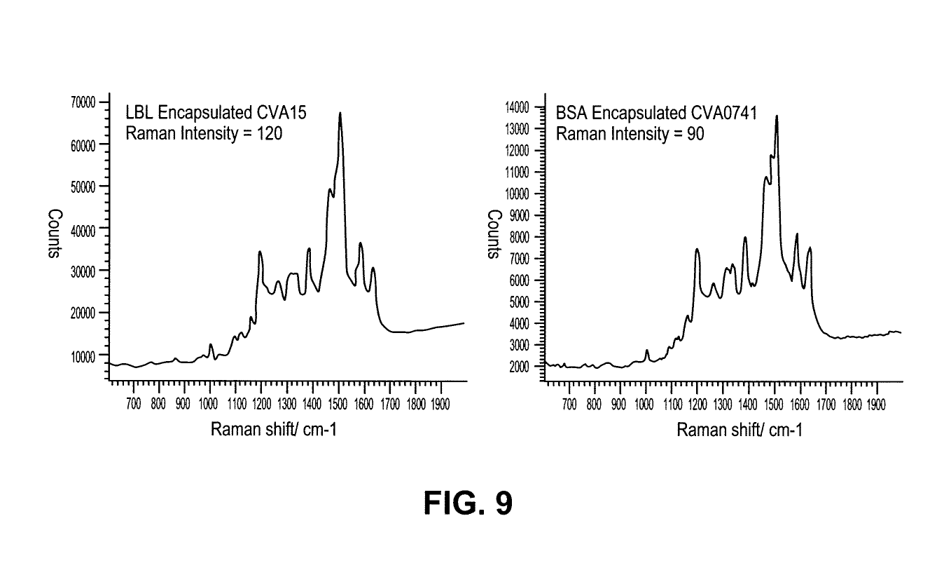

FIG. 9 provides a comparison of the Raman spectra obtained for LBL encapsulated CVA15 COIN nanoparticles and BSA encapsulated CVA0741 COIN nanoparticles. As can be seen from the figure, the encapsulation method does not affect the spectra obtained from the COIN nanoparticle reporters. CVA15 is the LBL coated CVA COIN that is coated with charged polymers. CVA0741 is a CVA COIN that was coated with BSA and the BSA was further crosslinked with glutaraldehyde.

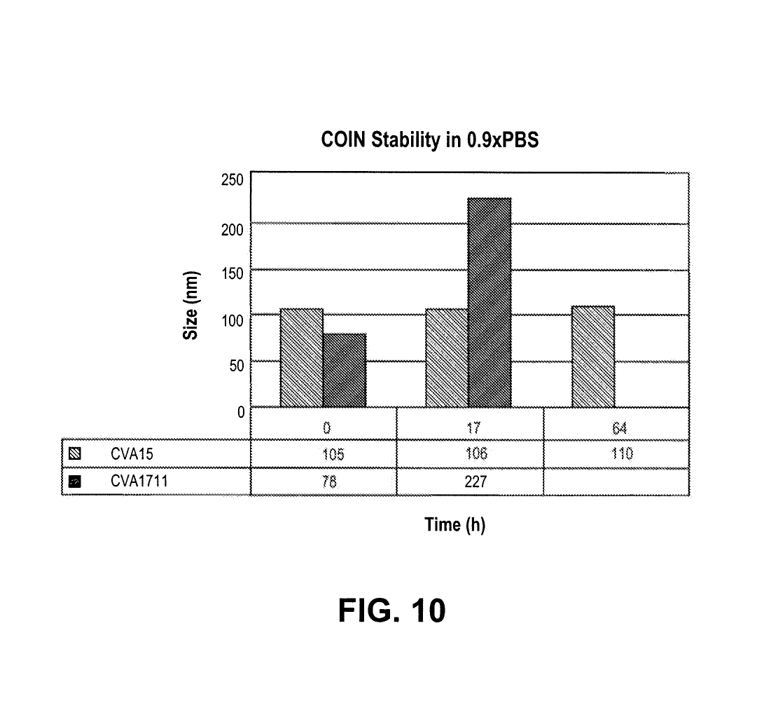

FIG. 10 provides a comparison of COIN nanoparticle stability over time for COINS in an aqueous PBS solution (0.9× phosphate buffered saline) that were encapsulated by two different methods. CVA1711 is a CVA COIN coated with BSA. CVA15 is a CVA COIN that had two coatings of charged polymer (one positively charged polymer coating and one negatively charged polymer coating). The polymer coatings were poly(allylamine) hydrochloride (molecular weight of 70 K) as the positive polymer coating material, and poly(acrylic acid) (molecular weight of 100 K) as the negative coating material. From FIG. 10 we can see that the BSA encapsulated COIN aggregated more rapidly, as compare to the one encapsulated with the LBL charged polymer coatings. After 17 hours, the sample CVA1711 had precipitated from solution.

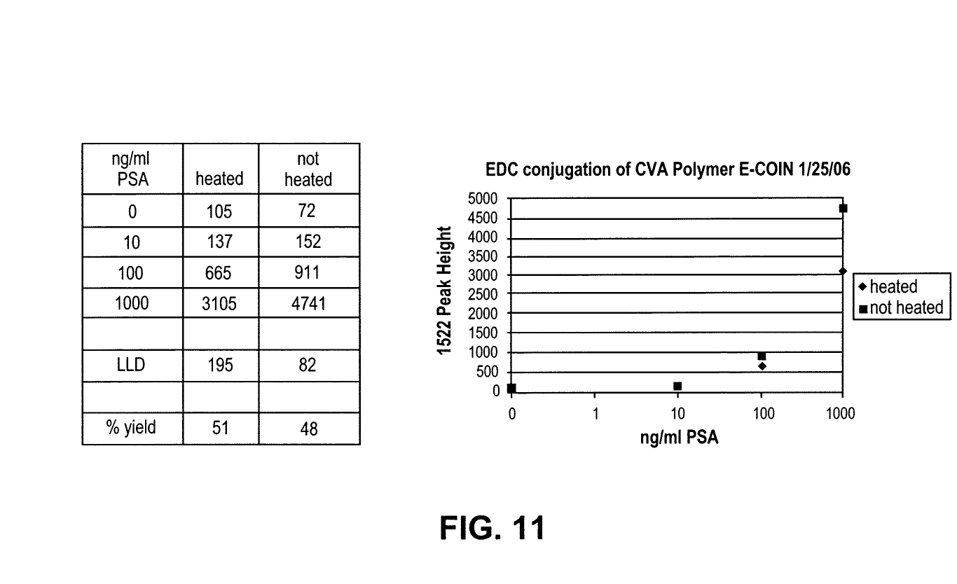

FIG. 11 provides results from the EDC conjugation and a bioassy using an LBL encapsulated Raman-active CVA COIN (encapsulated with two charged polymer layers). Carboxylic acid groups on the COIN surface were conjugated to free amine groups present in PSA antibodies. LBL CVA COIN nanoparticles (at concentration of 5 to 20 nM) were centrifuged and re-suspended in 10 mM borate buffer at pH 7.5. 3-5 mM of N-(3-Dimethylaminopropyl)-N′-ethylcarbodiimide (EDC) was added for 5 minutes and excess EDC was subsequently removed by centrifugation. An approximately 1000 fold excess of the PSA antibody was reacted with the activated COIN surface for 30 minutes. The resulting COIN antibody conjugates were washed 3 times to remove free antibody, and re-suspended in 10 mM borate, 1% BSA and 0.05% Tween-20. After the EDC conjugation, the following bioassay was carried out. The 16 wells on an aldehyde glass slide were separated using Fast Frame (Whatman, N.J., USA). Serial dilutions of purified PSA in 2× PBS and 90 μL per well were incubated at 37° C. for 2 hours in each well. After blocking with 3% BSA/PBS and two washes with PBS/0.05% Tween-20 (PBST), 50 μL of COIN-antibody conjugates (30 μM particle concentration) were incubated in the wells for 30 minutes. Slides were rinsed twice with PBST, and twice with 0.1M NaCl prior to Raman measurements. For the duplex direct binding assay, the Fast frame wells were coated with mixture of PSA and Cytokeratin-18 protein at concentration of 1000 ng/1 mL:0 ng/mL, 100 ng/mL: 10 ng/mL, 10 ng/mL, 100 ng/mL, and 0 ng/mL: 1000 ng/mL, respectively. 3 to 4 replicate wells were prepared for each analyte mixture. The direct binding assay was performed with 30 μM of each COIN-antibody conjugates (CVA-AbPSA). The Raman intensity was then measured for each well of the frame.

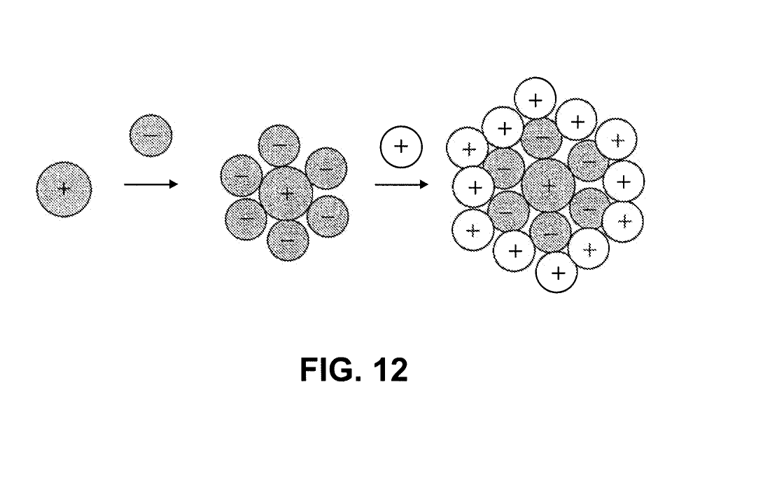

In additional nanocluster embodiments that may be coated with a LBL scheme, Raman-active nanoclusters having improved uniformity in size and Raman signal intensity as compared to less directed and or controlled nanocluster assembly procedures are provided. The uniformity of particle size and signal intensity enhances, for example, the reproducibility of, the ability to quantitate, and the accuracy of analyte detection procedures. A general method for obtaining nanoclusters having an improved uniform size distribution is shown in FIG. 12. Raman-active nanoclusters are assembled in FIG. 12 according to a concentric layer-by-layer approach around a central particle. Since aliquots of particles having opposite charges (indicated by “+” and “−” in the figure) are added to the forming cluster sequentially, a cluster having layers of oppositely charged particles is allowed to form. The chemical nature of the particles used in the layers of the nanoclusters can be either the same or different. When the particles of the layers are the same, their surfaces can be modified to provide opposite charges.

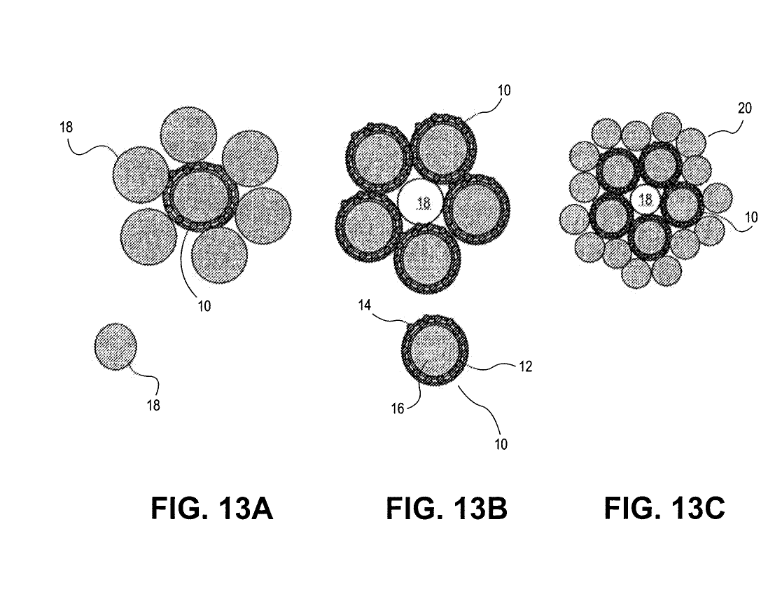

Referring now to FIGS. 13A, 13B, and 13C, simplified diagrams of three different cluster motifs are provided. The motifs shown in FIG. 13 are provided for illustration and represent several examples out of many possible Raman-active nanocluster motifs. In FIG. 13 A, a nanocluster is shown that is formed from a central nanoparticle 10 having one or more polymer layers 12 and a plurality of Raman label molecules 14 attached to a metal particle 16 and a plurality of metal nanoparticles 18 around the central polymer coated nanoparticle 10. The chemical composition of metal particles 18 may be the same or different from that of the central metal nanoparticle 16. FIG. 13B depicts a cluster formed from a central metal nanoparticle 18 surrounded by a plurality of particles 10 which are in turn comprised of a central metal particle 16, a polymer coating 12 and attached Raman labels 14. FIG. 13C shows a cluster comprised of three layers. In FIG. 13C, a cluster is comprised of a central nanoparticle 18, a first layer particles 10 comprised of a metal nanoparticle 16, an attached polymer layer 12 and a plurality of attached Raman labels 14. In general, a central metal particle may be the same or different sized than the surrounding metal particles. In addition, Raman label molecules may be linked to the central particle or the surrounding particle layer(s) and additional surrounding metal particle layers that either do have or do not have Raman labels may be added.

Particles used in certain embodiments of the invention to form nanoclusters are metal nanoparticles or coated metal nanoparticles. Metals that can be used include, for example, silver, gold, platinum, palladium, aluminum, copper, zinc, and iron. Additionally, the particles used to form nanoclusters may be comprised of more than metal. For example, the particle could be silver coated gold or vice versa.

In general, for applications using self-assembling nanoclusters as reporters for analyte detection, the average diameter of the self-assembling nanocluster should be less than about 200 nm. Typically, in analyte detection applications, self-assembling nanoclusters will range in average diameter from about 30 to about 200 nm. More preferably self-assembling nanoclusters range in average diameter from about 40 to about 200 nm, and more preferably from about 50 to about 200 nm, more preferably from about 50 to about 150 nm, and more preferably about 50 to about 100 nm.

To prepare colloidal metal nanoparticles, an aqueous solution is prepared containing suitable metal cations and a reducing agent. The components of the solution are then subject to conditions that reduce the metallic cations to form neutral, colloidal metal particles. In general, colloids are very small insoluble particles that are dispersed or suspended in a dispersion medium consisting of a phase that is different from the particle phase and either phase can be solid, liquid, or gas. In the present case, the silver colloid is a solid and the dispersion medium is a liquid, usually an aqueous solution.

The colloidal metal nanoparticles can vary in size, but are chosen to be smaller than the desired size of the resulting nanoclusters. For some applications, metal colloid particles ranging in average diameter from about 3 nm to about 80 nm are employed. Additionally, multi-metal nanoparticles may be used, such as, for example, silver nanoparticles having gold cores.

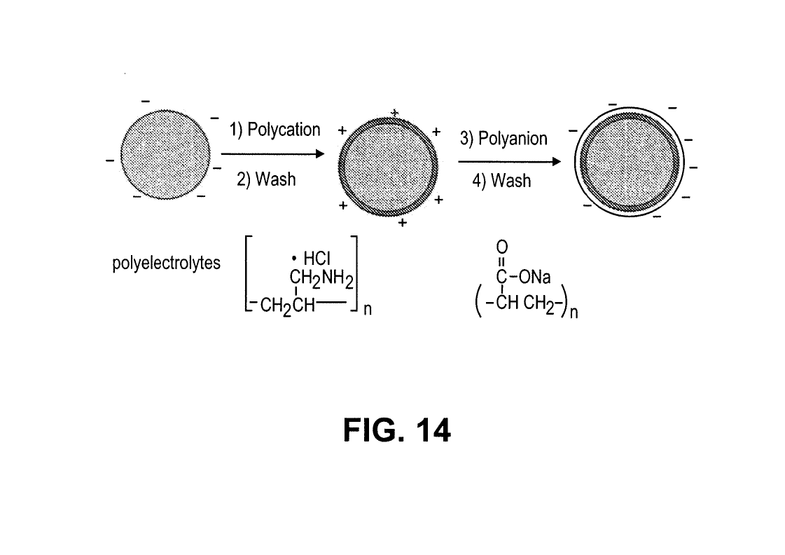

Nanoparticle surface charge reversal is achieved through the adsorption of a single layer of polyelectrolyte onto the particle surface. Large polymers can absorb onto metal particle surfaces almost irreversibly. Referring now to FIG. 14, a method is provided whereby a metal nanoparticle may be coated with one or more polymer layers. Exemplary polycation (polyamine) and polyanion (acetate) polyelectrolytes are shown in FIG. 14. By adding the desired positively charged polyelectrolyte to a solution of metal nanoparticles (having a negatively charged surface), nanoparticles having a layer of polyelectrolyte can be created. Similarly, a second layer of negatively charged polyelectrolyte, such as for example, polyacrylic acid, can be added to the nanoparticles having a first layer of polycation. Other possible polyelectrolytes include, for example, poly(ethylenimine), poly(4-vinylpyridine hydrochloride), polyaniline, polypyrrole, poly(sodium 4-styrenesulfate), poly(acrylic acid), and bio polymers, such as proteins with positive or negative surface charges, DNA and RNA (negatively charged), as well as copolymer and block polymers such as poly(ethylene-co-methacrylic acid) and poly (maleic acid-co-olefin).

In further embodiments, polyelectrolyte layers having enhanced stability are provided. Functional groups in the electrolytes can be crosslinked so that the particles are encaged. For example, the negatively charged silver particles may be coated with a polycation (e.g. polyethyleneimine or polyallyalamine) and then a portion of the amine groups are crosslinked with glutaraldehyde. After crosslinking with glutaraldehyde, the crosslinked polymer is reduced with sodium borohydride. In the reaction to create crosslinked polymers on the nanocluster surface, some of amine groups remain unreacted to provide the particle with positive charge. In further embodiments, a copolymer having different functional groups (e.g., amine and tertiary amine) is selected so that only amine groups are converted to the amide group and the tertiary amine groups remain to provide positive charges to the particles.

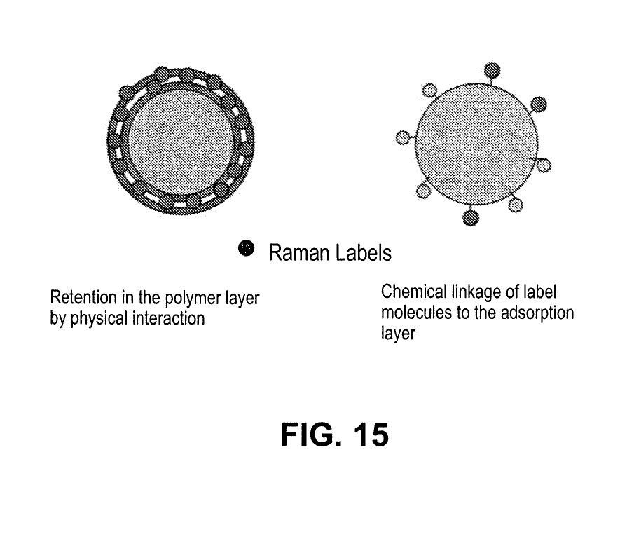

Referring now to FIG. 15, two exemplary approaches are shown for the introduction of Raman-active molecules into a nanocluster of metal particles. The first exemplary method shown in FIG. 15 is by physical absorption of the Raman label molecules into a polymer layer. When a relatively thick polymer layer is present, the label molecules can be absorbed and or retained in the layer through electrostatic and hydrophobic interactions. Polymer chains with different structures can be selected to favor the retention of a given type of Raman label molecule. As shown in FIG. 15, chemical reactions can also be used to link the Raman label molecules to the adsorption layer. The Raman label molecules will be first converted into reactive forms, if necessary, to react with the functional groups of various polymers. For example, for a polymer having an amine functional group (such as, for example, polyallylamine), the Raman label can be attached through, for example, a NHS ester group, an isothiocyanate group, and or through sulfyl halide groups. In the case of a polymer presenting carboxylic acid groups (such as for example, polyacrylic acid), a Raman label can be attached through carbodiimide functional group on the label. For polymers presenting thiol groups (such as for example, proteins), Raman labels can be attached through, for example, a haloacetyl group, a maleimide group, a disulphide group, and or a vinyl sulfone group. For polymers presenting a hydroxy group (such as for example polyvinyl alcohol), Raman labels can be attached, for example, through an isothiocyanate or a sulfonyl halide group. For polysaccharides, Raman labels can be attached, for example, through an amide functional group, followed by oxidation of the sugar.

Further, Raman label molecules may be introduced to the adsorption layer through polymerization or copolymerization. For example, a Raman label such as pyridine can be incorporated into a monomer, then polymerized to poly(4-vinylpyridine), which can be protonated with acid to form a positively charged polymer. In another example, a NH₂-containing label such as BFU (Basic Fuchsin) is treated with GMBS (N-maleimidobutyryloxysuccinimide ester) to couple a maleicamide group to the label, then the derivatized label is co-polymerized with another monomer such as allylamine to yield a cationic polymer loaded with BFU.

Raman-active nanoclusters may be stabilized and or functionalized with different types of coating layers and combinations of layers. Typical coatings or layers useful in embodiments of the present invention include coatings such as polymer layers, protein layers, silica layers, hematite layers, organic layers, and organic thiol-containing layers. Many of the layers, such as the adsorption layers and the organic layers provide additional mechanisms for probe attachment. For instance, layers presenting carboxylic acid functional groups allow the covalent coupling of a biological probe, such as an antibody, through an amine group on the antibody. One or more of these types of layer may be applied to the nanoparticle before the application of the oppositely charged polymer layers.

Raman-active nanoclusters can be complexed to a selected molecular analyte through a probe attached to the nanocluster that is specific for the selected analyte. In general, a probe is a molecule that is able to specifically bind an analyte and, in certain embodiments, exemplary probes are antibodies, antigens, polynucleotides, oligonucleotides, carbohydrates, proteins, cofactors, receptors, ligands, peptides, inhibitors, activators, hormones, cytokines, and the like. For example, the analyte can be a protein and the nanocluster is complexed to the analyte through an antibody that specifically recognizes the protein analyte of interest.

Specific binding is the specific recognition of one of two different molecules (a specific binding partner) for the other (specific binding partner) and substantially less recognition for other molecules. Generally, the molecules have areas on their surfaces or in cavities giving rise to specific recognition between the two molecules. A ligand is a molecule that binds to another molecule, usually referred to as a receptor. Usually, the term ligand is given to the smaller of the two molecules in the ligand-receptor pair, but it is not necessary for the purposes of the present invention for this to be the case. Exemplary specific binding partners and or ligand-receptor pairs include antibody antigen, enzyme substrate, lectin sugar, hormone or neurotransmitter receptor, and polynucleotide hybridization interactions.

Non-specific binding is non-covalent binding between molecules that is relatively independent of specific surface structures. Non-specific binding may result from several factors including hydrophobic interactions between molecules.

In some embodiments, a probe is an antibody. As used herein, the term antibody is used in its broadest sense to include polyclonal and monoclonal antibodies, as well as antigen binding fragments of such antibodies. An antibody useful in the present invention, or an antigen binding fragment thereof, is characterized, for example, by having specific binding activity for an epitope of an analyte. An antibody, for example, includes naturally occurring antibodies as well as non-naturally occurring antibodies, including, for example, single chain antibodies, chimeric, CDR-grafted, bifunctional, and humanized antibodies, as well as antigen-binding fragments thereof. Such non-naturally occurring antibodies can be constructed using solid phase peptide synthesis, can be produced recombinantly, or can be obtained, for example, by screening combinatorial libraries consisting of variable heavy chains and variable light chains.

Additionally, a probe can be a polynucleotide. A nanocluster-labeled oligonucleotide probe can be used in a hybridization reaction to detect a target polynucleotide. Polynucleotide is used broadly herein to mean a sequence of deoxyribonucleotides or ribonucleotides that are linked together by a phosphodiester bond. Generally, an oligonucleotide useful as a probe or primer that selectively hybridizes to a selected nucleotide sequence is at least about 10 nucleotides in length, usually at least about 15 nucleotides in length, for example between about 15 and about 50 nucleotides in length. Polynucleotide probes are particularly useful for detecting complementary polynucleotides in a biological sample and can also be used for DNA sequencing by pairing a known polynucleotide probe with a known Raman-active signal made up of a combination of Raman-active organic compounds as described herein.

A polynucleotide can be RNA or DNA, and can be a gene or a portion thereof, a cDNA, a synthetic polydeoxyribonucleic acid sequence, or the like, and can be single stranded or double stranded, as well as a DNA/RNA hybrid. In various embodiments, a polynucleotide, including an oligonucleotide (for example, a probe or a primer) can contain nucleoside or nucleotide analogs, or a backbone bond other than a phosphodiester bond. In general, the nucleotides comprising a polynucleotide are naturally occurring deoxyribonucleotides, such as adenine, cytosine, guanine, or thymine linked to 2′-deoxyribose, or ribonucleotides such as adenine, cytosine, guanine, or uracil linked to ribose. However, a polynucleotide or oligonucleotide also can contain nucleotide analogs, including non-naturally occurring synthetic nucleotides or modified naturally occurring nucleotides. One example of an oligomeric compound or an oligonucleotide mimetic that has been shown to have good hybridization properties is referred to as a peptide nucleic acid (PNA). In PNA compounds, the sugar-backbone of an oligonucleotide is replaced with an amide containing backbone, for example an aminoethylglycine backbone. In this example, the nucleobases are retained and bound directly or indirectly to an aza nitrogen atom of the amide portion of the backbone. PNA compounds are disclosed in Nielsen et al., Science, 254:1497-15 (1991), for example.

The covalent bond linking the nucleotides of a polynucleotide generally is a phosphodiester bond. However, the covalent bond also can be any of a number of other types of bonds, including a thiodiester bond, a phosphorothioate bond, a peptide-like amide bond or any other bond known to those in the art as useful for linking nucleotides to produce synthetic polynucleotides. The incorporation of non-naturally occurring nucleotide analogs or bonds linking the nucleotides or analogs can be particularly useful where the polynucleotide is to be exposed to an environment that can contain nucleolytic activity, including, for example, a tissue culture medium or upon administration to a living subject, since the modified polynucleotides can be less susceptible to degradation.

Raman-active nanoparticles can be coupled with probes through biotin-avidin coupling. For example, avidin or streptavidin (or an analog thereof) can be adsorbed to the surface of the nanoparticle and a biotin-modified probe contacted with the avidin or streptavidin-modified surface forming a biotin-avidin (or biotin-streptavidin) linkage. As discussed above, optionally, avidin or streptavidin may be adsorbed in combination with another protein, such as BSA, and/or optionally crosslinked. In addition, for nanoparticles having a functional layer that includes a carboxylic acid or amine functional group, probes having a corresponding amine or carboxylic acid functional group can be attached through water-soluble carbodiimide coupling reagents, such as EDC, which couples carboxylic acid functional groups with amine groups. Further, functional layers and probes can be provided that possess reactive groups such as, esters, hydroxyl, hydrazide, amide, chloromethyl, aldehyde, epoxy, tosyl, thiol, and the like, which can be joined through the use of coupling reactions commonly used in the art. For example, Aslam, M and Dent, A, Bioconjugation: Protein Coupling Techniques for the Biomedical Sciences, Grove's Dictionaries, Inc., (1998) provides additional methods for coupling biomolecules, such as, for example, thiol maleimide coupling reactions, amine carboxylic acid coupling reactions, amine aldehyde coupling reactions, biotin avidin (and derivatives) coupling reactions, and coupling reactions involving amines and photoactivatable heterobifunctional reagents.

Nucleotides attached to a variety of tags may be commercially obtained (for example, from Molecular Probes, Eugene, Oreg.; Quiagen (Operon), Valencia, Calif.; and IDT (Integrated DNA Technologies), Coralville, Iowa) and incorporated into oligonucleotides or polynucleotides. Oligonucleotides may be prepared using commercially available oligonucleotide synthesizers (for example, Applied Biosystems, Foster City, Calif.). Additionally, modified nucleotides may be synthesized using known reactions, such as for example, those disclosed in, Nelson, P., Sherman-Gold, R., and Leon, R., “A New and Versatile Reagent for Incorporating Multiple Primary Aliphatic Amines into Synthetic Oligonucleotides,” Nucleic Acids Res., 17:7179-7186 (1989) and Connolly, B., Rider, P., “Chemical Synthesis of Oligonucleotides Containing a Free Sulfhydryl Group and Subsequent Attachment of Thiol Specific Probes,” Nucleic Acids Res., 13:4485-4502 (1985). Alternatively, nucleotide precursors may be purchased containing various reactive groups, such as biotin, hydroxyl, sulfhydryl, amino, or carboxyl groups. After oligonucleotide synthesis, nanocluster labels may be attached using standard chemistries. Oligonucleotides of any desired sequence, with or without reactive groups for nanocluster attachment, may also be purchased from a wide variety of sources (for example, Midland Certified Reagents, Midland, Texas).

An analyte can be any molecule or compound in the solid, liquid, gaseous or vapor phase. By gaseous or vapor phase analyte is meant a molecule or compound that is present, for example, in the headspace of a liquid, in ambient air, in a breath sample, in a gas, or as a contaminant in any of the foregoing. It will be recognized that the physical state of the gas or vapor phase can be changed for example, by pressure, temperature as well as by affecting surface tension of a liquid by the presence of or addition of salts.

The analyte can be comprised of a member of a specific binding pair (sbp) and may be a monovalent ligand (monoepitopic) or polyvalent ligand (polyepitopic), usually antigenic or haptenic, and is a single compound or plurality of compounds which share at least one common epitopic or determinant site. The analyte can be derived from a cell such as bacteria or a cell bearing a blood group antigen such as A, B, D, etc., or an HLA antigen or a microorganism, for example, bacterium, fungus, protozoan, prion, or virus. In certain aspects of the invention, the analyte is charged. A biological analyte could be, for example, a protein, a carbohydrate, or a nucleic acid.

The nanoparticles of the present invention may be used to detect the presence of a particular target analyte, for example, a protein, enzyme, polynucleotide, carbohydrate, antibody, or antigen. The nanoparticles may also be used to screen bioactive agents, such as, drug candidates, for binding to a particular target or to detect agents like pollutants. As discussed above, any analyte for which a probe moiety, such as a peptide, protein, or aptamer, may be designed can be used in combination with the disclosed nanoparticles.

Molecular analytes include antibodies, antigens, polynucleotides, oligonucleotides, proteins, enzymes, polypeptides, polysaccharides, cofactors, receptors, ligands, and the like. The analyte may be a molecule found directly in a sample such as a body fluid from a host. The sample can be examined directly or may be pretreated to render the analyte more readily detectible. Furthermore, the analyte of interest may be determined by detecting an agent probative of the analyte of interest such as a specific binding pair member complementary to the analyte of interest, whose presence will be detected only when the analyte of interest is present in a sample. Thus, the agent probative of the analyte becomes the analyte that is detected in an assay. The body fluid can be, for example, urine, blood, plasma, serum, saliva, semen, stool, sputum, cerebral spinal fluid, tears, mucus, and the like. Methods for detecting target nucleic acids are useful for detection of infectious agents within a clinical sample, detection of an amplification product derived from genomic DNA or RNA or message RNA, or detection of a gene (cDNA) insert within a clone. Detection of the specific Raman label on the captured nanocluster labeled oligonucleotide probe identifies the nucleotide sequence of the oligonucleotide probe, which in turn provides information regarding the nucleotide sequence of the target polynucleotide.

In addition, the detection target can be any type of animal or plant cell, or unicellular organism. For example, an animal cell could be a mammalian cell such as an immune cell, a cancer cell, a cell bearing a blood group antigen such as A, B, D, etc., or an HLA antigen, or virus-infected cell. Further, the target cell could be a microorganism, for example, bacterium, algae, or protozoan. The molecule bound by the probe is present on the surface of the cell and the cell is detected by the presence of a known surface feature (analyte) through the complexation of a Raman-active nanocluster to the target cell-surface feature. In general, cells can be analyzed for one or more surface features through the complexation of at least one uniquely labeled nanocluster to a known surface feature of a target cell. Additional surface features can be detected through the complexation of a differently labeled nanocluster to a second known surface feature of the target cell, or the complexation of two differently labeled Raman-active nanoclusters to a second and third surface feature, and so on. One or more cells can be analyzed for the presence of a surface feature through the complexation of a uniquely labeled nanocluster to a known surface feature of a target cell.

Cell surface targets include molecules that are found attached to or protruding from the surface of a cell, such as, proteins, including receptors, antibodies, and glycoproteins, lechtins, antigens, peptides, fatty acids, and carbohydrates. The cellular analyte may be found, for example, directly in a sample such as fluid from a target organism. The sample can be examined directly or may be pretreated to render the analyte more readily detectible. The fluid can be, for example, urine, blood, plasma, serum, saliva, semen, stool, sputum, cerebral spinal fluid, tears, mucus, and the like. The sample could also be, for example, tissue from a target organism.

A marker molecule is a molecule present in a system that allows the detection and or identification of a disease state. Disease markers may be a genetic host factor predisposing to the disease or the occurrence of cell-surface markers, enzymes, or other components, either in altered forms, abnormal concentrations or with abnormal tissue distribution. For example, tumor markers are frequently substances that can be detected in higher-than-normal amounts in blood, urine, or body tissue of some animals with certain types of cancer. The tumor marker may be made by the tumor itself or by the body in response to the tumor. The tumor marker level may also indicate the extent or stage of the disease, how quickly the cancer is likely to progress, and the prognosis.

In general, peptides are polymers of amino acids, amino acid mimics or derivatives, and/or unnatural amino acids. The amino acids can be any amino acids, including α, β, or ω-amino acids and modified amino acids. When the amino acids are α-amino acids, either the L-optical isomer or the D-optical isomer may be used. A peptide can alternatively be referred to as a polypeptide. Peptides contain two or more amino acid monomers, and often more than 50 amino acid monomers (building blocks).

A protein is a long polymer of amino acids linked via peptide bonds and which may be composed of one or more polypeptide chains. More specifically, the term protein refers to a molecule comprised of one or more polymers of amino acids. Proteins are essential for the structure, function, and regulation of the body's cells, tissues, and organs, and each protein has unique functions. Examples of proteins include some hormones, enzymes, and antibodies.

In the practice of embodiments of the present invention, a Raman spectrometer can be part of a detection unit designed to detect and quantify nanoparticles of the present invention by Raman spectroscopy. Methods for detection of Raman labeled analytes, for example nucleotides, using Raman spectroscopy are known in the art. (See, for example, U.S. Pat. Nos. 5,306,403; 6,002,471; 6,174,677). A non-limiting example of a Raman detection unit is disclosed in U.S. Pat. No. 6,002,471. An excitation beam is generated by either a frequency doubled Nd:YAG laser at 532 nm wavelength or a frequency doubled Ti:sapphire laser at 365 nm wavelength. Pulsed laser beams or continuous laser beams may be used. The excitation beam passes through confocal optics and a microscope objective, and is focused onto the flow path and/or the flow-through cell. The Raman emission light from the labeled nanoparticles is collected by the microscope objective and the confocal optics and is coupled to a monochromator for spectral dissociation. The confocal optics includes a combination of dichroic filters, barrier filters, confocal pinholes, lenses, and mirrors for reducing the background signal. Standard full field optics can be used as well as confocal optics. The Raman emission signal is detected by a Raman detector, which includes an avalanche photodiode interfaced with a computer for counting and digitization of the signal.

Another example of a Raman detection unit is disclosed in U.S. Pat. No. 5,306,403, including a Spex Model 1403 double-grating spectrophotometer with a gallium-arsenide photomultiplier tube (RCA Model C31034 or Burle Industries Model C3103402) operated in the single-photon counting mode. The excitation source includes a 514.5 nm line argon-ion laser from SpectraPhysics, Model 166, and a 647.1 nm line of a krypton-ion laser (Innova 70, Coherent).

Alternate excitation sources include a nitrogen laser (Laser Science Inc.) at 337 nm and a helium-cadmium laser (Liconox) at 325 nm (U.S. Pat. No. 6,174,677), a light emitting diode, an Nd:YLF laser, and/or various ions lasers and/or dye lasers. The excitation beam may be spectrally purified with a bandpass filter (Corion) and may be focused on the flow path and/or flow-through cell using a 6× objective lens (Newport, Model L6X). The objective lens may be used to both excite the Raman-active organic compounds of the Raman-active nanoclusters and to collect the Raman signal, by using a holographic beam splitter (Kaiser Optical Systems, Inc., Model HB 647-26N18) to produce a right-angle geometry for the excitation beam and the emitted Raman signal. A holographic notch filter (Kaiser Optical Systems, Inc.) may be used to reduce Rayleigh scattered radiation. Alternative Raman detectors include an ISA HR-320 spectrograph equipped with a red-enhanced intensified charge-coupled device (RE-ICCD) detection system (Princeton Instruments). Other types of detectors may be used, such as Fourier-transform spectrographs (based on Michaelson interferometers), charged injection devices, photodiode arrays, InGaAs detectors, electron-multiplied CCD, intensified CCD and/or phototransistor arrays.

Any suitable form or configuration of Raman spectroscopy or related techniques known in the art may be used for detection of the nanoparticles of the present invention, including but not limited to normal Raman scattering, resonance Raman scattering, surface enhanced Raman scattering, surface enhanced resonance Raman scattering, coherent anti-Stokes Raman spectroscopy (CARS), stimulated Raman scattering, inverse Raman spectroscopy, stimulated gain Raman spectroscopy, hyper-Raman scattering, molecular optical laser examiner (MOLE) or Raman microprobe or Raman microscopy or confocal Raman microspectrometry, three-dimensional or scanning Raman, Raman saturation spectroscopy, time resolved resonance Raman, Raman decoupling spectroscopy or UV-Raman microscopy.

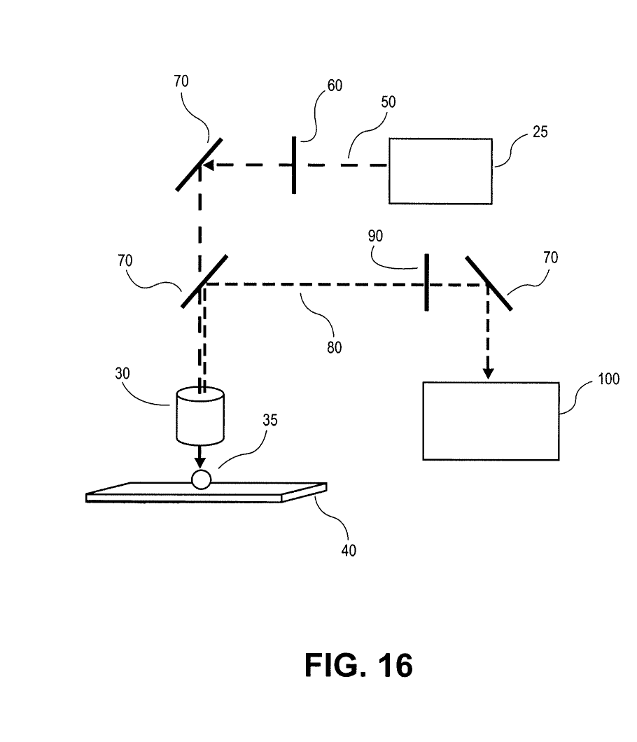

FIG. 16 shows a schematic of a Raman spectrometer setup that was used for the SERS measurements. The system consisted of a titanium:sapphire laser 25 (Mira by Coherent, Santa Clara, Calif.) operating at 785 nm with power levels of about 750 mW, and a 20× microscope objective 30 (Nikon LU series) to focus the laser spot onto the sample plane. The sample 35 was placed on a substrate 40. The excitation beam 50 was filtered by a dielectric filter 60 (Chroma Technology Corp., Brattleboro, Vt.), to suppress spontaneous emission from the laser and reflected from a dichroic mirror 70 (Chroma Technology Corp., Brattleboro, Vt.). The Raman scattered light 80 from the sample 30 was collected by the same microscope objective 20, and was reflected off the dichroic mirror 70 toward a notch filter or bandpass filter 90 (Kaiser Optical Systems, Ann Arbor, Mich.). The notch filter 90 blocked the laser beam and transmitted Raman scattered light 80. The Raman-scattered light was imaged onto the slit of a spectrophotometer 100 (Acton Research Corp., Acton, Mass.) (using dichroic mirror 70) that was connected to a thermo-electrically cooled charge-coupled device (CCD) detector (Princeton Instruments, Princeton, N.J.) (not shown). The CCD camera was connected to a PC (not shown), and the collected spectrum was transported to the PC for visual display and computational analysis.

1. A nanoparticle capable of providing a detectable signal when excited by electromagnetic radiation, wherein the nanoparticle comprises two or more layers comprising charged polymer molecules, wherein the charge of a first polymer layer is opposite that of a second proximate polymer layer, and wherein the nanoparticle also comprises a probe molecule that is capable of specifically attaching to an analyte substance.

2. The nanoparticle of claim 1 wherein a negative charge on a charged polymer molecule is created by carboxylate functional groups of the polymer molecule.

3. The nanoparticle of claim 1 wherein a positively charged polymer is selected from the group consisting of poly(vinylamine), poly(allylamine), poly-lysine, and copolymers thereof.

4. The nanoparticle of claim 1 wherein at least one of the charged polymer layers is comprised of crosslinked polymers.

5. The nanoparticle of claim 1 wherein the charged polymer of at least one of the charged polymer layers has a molecular weight of 2,000 to 3,000,000.

6. The nanoparticle of claim 1 wherein the nanoparticle comprises three or more charged polymer layers and wherein the charge of one polymer layer is opposite the charge of the two or more other polymer layers.

7. The nanoparticle of claim 1 wherein the probe is selected from the group consisting of antibodies, antigens, polynucleotides, oligonucleotides, receptors, carbohydrates, cofactors, and ligands.

8. The nanoparticle of claim 1 wherein the nanocluster has an average diameter of about 20 nm to about 200 nm.

9. The nanoparticle of claim 1 wherein the detectable signal is a surface enhanced Raman (SERS) signal.

10. The nanoparticle of claim 9 wherein the nanoparticle is comprised of a metal selected from the group consisting of silver, gold, copper, palladium, platinum, and aluminum.

11. A nanocluster of metal particles having a unique Raman signature, wherein the unique Raman signature is produced by at least one Raman active organic compound incorporated within the nanocluster, and wherein the nanocluster comprises two or more layers comprising charged polymer molecules, wherein the charge of a first polymer layer is opposite that of a second proximate polymer layer, and wherein the nanocluster also comprises a probe molecule that is capable of specifically attaching to an analyte substance.

12. The nanocluster of claim 11 wherein a negative charge on a charged polymer molecule is created by carboxylate functional groups of the polymer molecule.

13. The nanocluster of claim 11 wherein at least one of the charged polymer layers is comprised of crosslinked polymers.

14. The nanocluster of claim 11 wherein the charged polymer of at least one of the charged polymer layers has a molecular weight of 2,000 to 3,000,000.

15. The nanocluster of claim 11 wherein the nanocluster comprises three or more charged polymer layers and wherein the charge of one polymer layer is opposite the charge of the two or more other polymer layers.

16. The nanocluster of claim 11 wherein the probe is selected from the group consisting of antibodies, antigens, polynucleotides, oligonucleotides, receptors, carbohydrates, cofactors, and ligands.

17. The nanocluster of claim 11 wherein the nanocluster has an average diameter of about 20 nm to about 200 nm.

18. The nanocluster of metal particles of claim 11 wherein the nanocluster is comprised of a metal selected from the group consisting of silver, gold, copper, palladium, platinum, and aluminum.

19. The nanocluster of claim 11 wherein the unique Raman signature is produced by at least two Raman active organic compounds having different distinctive Raman signatures incorporated within the nanocluster.

20. A nanocluster of metal particles capable of displaying an enhanced Raman signature, wherein the enhanced Raman signature is produced from a plurality of Raman active organic molecules incorporated within the nanocluster, and wherein the nanocluster is comprised of a plurality of metal particles wherein one of the plurality of metal particles has a surface charge that is opposite that of another of the plurality of metal particles; and wherein the nanocluster comprises two or more surface layers comprising charged polymer molecules, wherein the charge of a first polymer layer is opposite that of a second proximate polymer layer, and wherein the nanocluster also comprises a probe molecule that is capable of specifically attaching to an analyte substance.

21. The nanocluster of claim 20 wherein a negative charge on a charged polymer molecule is created by carboxylate functional groups of the polymer molecule.

22. The nanocluster of claim 20 wherein at least one of the charged polymer layers is comprised of crosslinked polymers.

23. The nanocluster of claim 20 wherein the charged polymer of at least one of the charged polymer layers has a molecular weight of 2,000 to 3,000,000.

24. The nanocluster of claim 20 wherein the nanocluster comprises three or more charged polymer layers and wherein the charge of one polymer layer is opposite the charge of the two or more other polymer layers.

25. The nanocluster of claim 20 wherein the probe is selected from the group consisting of antibodies, antigens, polynucleotides, oligonucleotides, receptors, carbohydrates, cofactors, and ligands.

26. The nanocluster of claim 20 wherein the nanocluster has an average diameter of about 20 nm to about 200 nm.

27. The nanocluster of metal particles of claim 20 wherein the nanocluster is comprised of a metal selected from the group consisting of silver, gold, copper, palladium, platinum, and aluminum.

28. The nanocluster of claim 20 wherein the unique Raman signature is produced by at least two Raman active organic compounds having different distinctive Raman signatures incorporated within the nanocluster.

29. The nanocluster of claim 20 wherein the charge on a metal particle is created by a layer of cationic polymer adsorbed onto the nanoparticle.

30. The nanocluster of claim 20 wherein the charge on a metal particle is created by a layer of anionic polymer adsorbed onto the nanoparticle.
